(19) United States
(12) Patent Application Publication
(10) Pub. No.: US 2026/0304248 A1
(43) Pub. Date: Oct. 1, 2026

(54) SYSTEMS AND METHODS FOR THE CORRECTION OF TIMING ADVANCE ESTIMATIONS FOR COMMUNICATIONS NETWORK CORRECTION

(71) Applicant: NetScout Systems, Inc., Westford, MA (US)

(72) Inventor: Imran Hafeez, Allen, TX (US)

(73) Assignee: NetScout Systems, Inc., Westford, MA (US)

(21) Appl. No.: 19/096,054

(22) Filed: Mar. 31, 2025

(51) Int. Cl. H04W 36/00; H04W 36/08; H04W 36/32; H04W 56/00

(52) U.S. Cl. CPC H04W 36/0072; H04W 36/08; H04W 36/322; H04W 56/001

(57) ABSTRACT

Aspects of the technical solutions described herein relate to a system that can monitor signal records of the communications network of different communications sessions between client devices and computing devices over the communications network. The system can detect a signal record for a communications session between a first client device and a computing device. The system can identify a first TA for a period of the first communications session through a first cell and a second TA for a period of the first communications session end through a second cell after the handover from the first cell to the second cell. The system can determine a network synchronization offset as a function of the first TA and the second TA and generate a record identifying a geolocation of a second client device participating in a second communications session through the first cell or the second cell.

### BACKGROUND

Communications sessions may be detected within a communication network between one or more cells. A timing advance (TA) is an important parameter in Cellular Service Provider (CSP) LTE and 5G networks that ensures synchronized uplink/downlink transmission from user equipment (UEs) to the base station. The TA can compensate for the propagation delay, which is the time it takes for a signal to travel from the UE to the base station and vice versa. This is done as part of network planning and results in CSPs adjusting/configuring different TA values depending upon the various morphology of their networks like downtown areas vs rural areas. The TA can be a combination of synchronization granularity (offset) and propagation delay between the UE and base station. Synchronization granularity can be thought of as an offset that needs to be present regardless. The TA value can be expressed in units of nanoseconds. The range of TA values depends on the specific LTE/5G network configuration, but it generally falls within a few hundred to a few thousand nanoseconds.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 is an illustration of a system for the correction of timing advance estimations, in accordance with an implementation;

FIG. 2 is an illustration of a method for the correction of timing advance estimations, in accordance with an implementation;

FIG. 3 is an illustration of a block diagram of a process for cell handovers during a communications session, in accordance with an implementation;

FIG. 4 is an example of a call trace scenario during the communications session, in accordance with an implementation;

FIG. 5 is another example of a call trace scenario during the communications session, in accordance with an implementation;

FIG. 6 is an example of record generated using the correction of the timing advance correction, in accordance with an implementation;

FIG. 7A is a block diagram depicting an implementation of a network environment including a client device in communication with a server device;

FIG. 7B is a block diagram depicting a cloud computing environment including a client device in communication with cloud service providers; and

FIG. 7C is a block diagram depicting an implementation of a computing device that can be used in connection with the systems depicted in FIG. 1, and the methods depicted in FIG. 2.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

Geographic accuracy is at least one aspect of radio access network (RAN) product line. Geo-location algorithms use network provided Timing Advance (TA) as one of the sources for determining the distance of the UE from the cell site. The TA provided by the network can be different from the actual distance to the UE from the cell. Thus, reducing or minimizing this delta can be directly proportional to increasing the accuracy of geo-location and subsequently improving the quality of metrics across RAN product line.

Conventional methods of estimating TA include drive tests with global positioning system (GPS) scanners and minimization of drive testing (MDT) data. In the drive tests, the distance between the client device and the respective cells are measured using one or more GPS scanners. However, these drive tests are computationally expensive and can only be executed with a minimized number of cells. Therefore, a number of cells may not be included within the drive tests of the network causing incorrect and inaccurate TA estimations. The MDT can include data associated with the performance of the network and the location of the client device to calculate and estimate the TA. However, MDT is not accessible for respective networks and are often inaccurate in comparison to GPS scanners.

The systems and methods described herein may efficiently provide accurate corrections to timing advance (TA) estimations. TA can be determined using initial random access procedures to ensure that uplink (UL) transmissions from client device (client device) are synchronized when received by a cell or a base station (BS). To provide accurate corrections, it can be desirable for a network offset to be applied to the TA to remove the use of global positing data (GPS) and minimization of drive test (MDT) data for location determination.

The systems and methods described herein address each of these challenges by calculating and generating a correction offset for the TA estimation without the use of GPS data, thereby reducing the computational cost to generate the TA. For example, the system can monitor signal records within the communication network. The signal records can correspond to various communications sessions between client devices or computing devices. The system can then detect an active signal record for a communications session initiated by a client device and the computing device that occurs within the cells of the communication network.

The system can identify a TA (e.g., first TA) for a period of the communications session through a first cell. The period can correspond to the start of the communications session through the first cell until a cell handover occurs (e.g., a time period of the communications session when the client device is connected with the first cell before a handover into a different cell). The first TA can be the TA when the communications session was initiated. The cell handover can indicate a new period of the communications session that occurs through a second cell. The system can identify a TA (e.g., second TA) for a period of the communications session through the second cell. The second TA can be the TA when the communications session ended. The subsequent period can correspond to the end of the communications session through the second cell (e.g., a time period of the communications session when the client device is connected with the second cell before the communications session ends). From here, the system can determine a network synchronization offset as a function of the first TA and the second TA. The network synchronization offset an indicate a correction value for the TA, such that the TA can be adjusted based on the network synchronization offset. The system can use a distance associated with the client device and the corrected TA to initiate a triangulation to accurately identify the geolocation of the client device.

Thus, the system can apply the network synchronization offset to identify an accurate geolocation for the client device or a subsequent client device without the use of GPS data, which can reduce the computational resources used by various computing devices, servers, or terminals at a data center. Furthermore, the process can reduce processing times and improve the accuracy of the geolocations of the client devices within the communications network. By avoiding the use of the drive tests, the process can be expanded to each cell within the range of a respective data center to increase the availability to correct the TA associated with various cells and reduce the computational expense associated with using drive tests. Moreover, the systems and methods described herein can be enabled for every computing network and improve mobility scenarios associated with cell handovers. Finally, the systems and methods described herein can facilitate real-time improvement of network communications by adjusting the orientations of antennas servicing cells based on offsets that the system detects, such as by adjusting (e.g., automatically adjusting using a control signal) the orientations responsive to determining an offset for a cell or antenna servicing the cells exceeds a threshold.

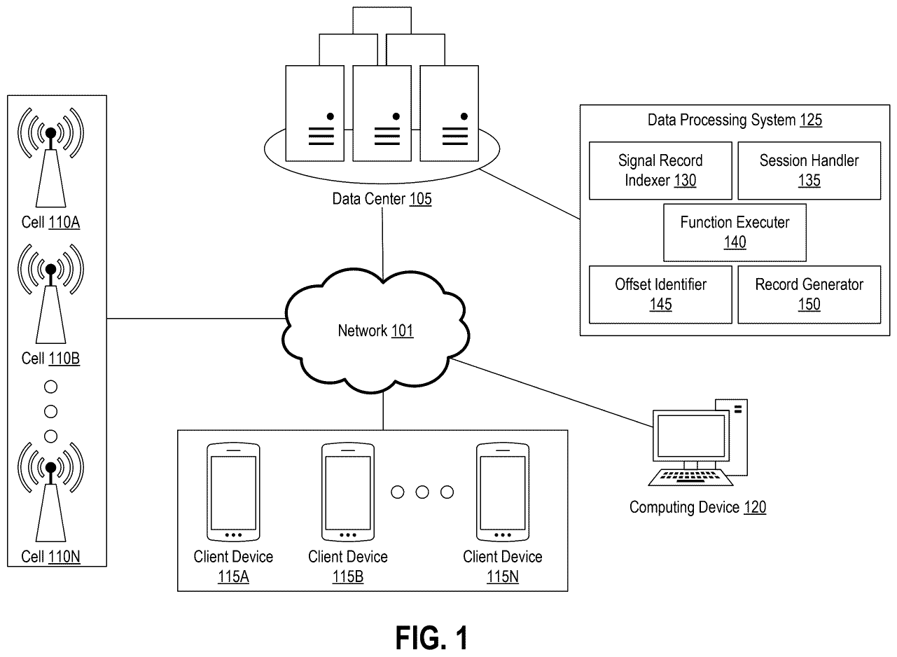

FIG. 1 is an illustration of a system 100 for the correction of TA estimations. The system 100 can be used to generate corrections for TA estimation. In a brief overview, the system 100 can include at least one data center 105, a plurality of cells 110A-N(referred to as cells 110 herein), a plurality of client devices 115A-N(referred to as a client devices 115 herein), at least one computing device 120 interconnected via a network 101. The data center 105 can interface with at least one data processing system 125 to perform the various tasks and processes described herein.

The network 101 may be any type or form of network and may include any of the following: a point-to-point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. The network 101 may include a wireless link, such as an infrared channel or satellite band. The topology of the network 101 may include a bus, star, or ring network topology. The network may include mobile telephone networks using any protocol or protocols used to communicate among mobile devices, including advanced mobile phone protocol (“AMPS”), time division multiple access (“TDMA”), code-division multiple access (“CDMA”), global system for mobile communication (“GSM”), general packet radio services (“GPRS”), universal mobile telecommunications system (“UMTS”), 3G, 4G, long term evolution wireless broadband communication (“LTE”), 5G, etc. Different types of data may be transmitted via different protocols, or the same types of data may be transmitted via different protocols. In some embodiments, the network 101 may be or include a self-organizing network that implements a machine learning model to automatically adjust connections and configurations of network elements of network 101 to optimize network connections (e.g., minimize latency, reduce dropped calls, increase data rate, increase quality of service, etc.).

Each of the client devices 115, the cells 110, the computing device 120, and/or the data processing system 125 of the data center 105 can include or utilize at least one processing unit or other logic device such as programmable logic array engine, or module configured to communicate with one another or other resources or databases. The components of the client devices 115, the cells 110, the computing device 120, and/or the data processing system 125 can be separate components or a single component. In some embodiments, the data processing system 125 of the data center 105 may be an intermediary device between the client devices 115 and the cells 110. In some embodiments, the computing device 120 may be an external device (e.g., a security device, a monitoring device, etc.). In some embodiments, the computing device 120, the client device 115, the data processing system 125, or any combination thereof, may share at least some components or be the same device. The system 100 and its components can include hardware elements, such as one or more processors, logic devices, or circuits.

The data center 105, the cells 110, the client devices 115, the computing device 120, can include or execute on one or more processors or computing devices and/or communicate via the network 101. The network 101 can include communication channels such as downlink channels (e.g., physical downlink shared channel, physical downlink control channel, physical broadcast channel, paging channels), uplink channels (e.g., physical uplink shared channel, physical uplink control channel, sounding reference signals), synchronization signals, reference signals, among other channels. Via the network 101, the client device 115 can initiate a communications session with another client device 115 or the computing device 120, such as a laptop, a desktop, a, tablet, personal digital assistant, smart phone, portable computers, or speaker.

The data center 105 can be hosted by a third-party cloud service provider via a virtual environment. The data center 105 can be hosted in a public cloud, a co-location facility, or a private cloud. The data center 105 can be hosted in a private data center, or on one or more physical servers, virtual machines, or containers of an entity or customer. The service providers 108 may each be or include servers or computers configured to transmit or provide services across network 101 to client devices 106. The service providers 108 may transmit or provide such services upon receiving requests for the services from any of the client devices 106. The term “service” as used herein includes the supplying, providing, receiving, or obtaining of information over a network and is also referred to as a communications network service. Examples of services include 5G broadband services, any voice, data or video service provided over a network, smart-grid network, digital telephone service, cellular service, Internet protocol television (IPTV), etc. The service may further include a SaaS application, such as a word processing application, spreadsheet application, presentation application, electronic message application, file storage system, productivity application, or any other SaaS application.

The cell 110 (sometimes referred to as base station 110 (BS) herein) can be a communication device (e.g., fixed communication device) that initiates, manages, or executes various communications sessions. The cell 110 can connect to a plurality of client devices 115 with range of a respective cell. When the client devices 115 are within range of a respective cell, the cell 110 can allow the client devices 115 or computing devices 120 to communicate effectively with each other. In some instances, the client devices 115 can communicate with the computing devices 120 within range of a respective cell 110. The cells 110 can coordinate signal transmission and signal reception, network connectivity, signal amplification, signal processing, time synchronization, among other functions. To initiate a communications sessions, the client devices 115 can search for available networks or cells to manage the communications session. The cells 110 can establish a call route, assign a traffic channel (TCH) and establish a communication link. Examples of the cells 110 can include microcell base stations, microcell base stations, Node B, eNode B, gNode B, satellite base stations, two-way radio base stations, Wi-Fi Access Points, among other base stations.

The client devices 115 can be located or deployed at any geographic location in the network environment as depicted in FIG. 1. The client devices 115 can be deployed, for example, at a geographic location where a typical user using the client devices 115 would seek to connect to a network (e.g., establish a communications session that requires communication across a network). For example, a user can use a client device 115 to contact another client device 115 or computing device 120 at home, as a passenger in a car, while riding a bus, in the park, at work, while eating at a restaurant, or in any other environment. The client devices 115 can be deployed at a separate site. The computing device 120 may be similar to client devices 115.

The data center 105 can house the data processing system 125 that comprises one or more processors that are configured to obtain network data packets from the data center 105 during a communications session between the client device 115 and the client device 115 or the computing device 120. The data processing system 125 can include one or more processors that may be or include an ASIC, one or more FPGAs, a DSP, circuits containing one or more processing components, circuitry for supporting a microprocessor, a group of processing components, or other suitable electronic processing components. In some embodiments, the one or more processors may execute computer code or modules (e.g., executable code, object code, source code, script code, machine code, etc.) stored in the memory to facilitate the operations described herein. The memory may be any volatile or non-volatile computer-readable storage medium capable of storing data or computer code.

In further detail, the data processing system 125 can include at least one signal record indexer 130, at least one session handler 135, at least one function executer 140, at least one offset identifier 145, and at least one record generator 150. The signal record indexer 130 can monitor, identify, or otherwise index signal records of a communications network. The session handler 135 can detect, identify, or otherwise indicate a signal record for a communications session between the client device 115 and the computing device 120. The function executer 140 can execute, apply, or otherwise perform a function on a first TA and a second TA. The offset identifier 145 can determine, identify, or otherwise indicate a network synchronization offset for the TA. The record generator 150 can generate, create, or otherwise determine a record.

In a brief overview, the signal record indexer 130 executing on the data center 105 can monitor, identify, or otherwise index signal records of a communications network. The signal records can be a log, a record, or list of signals transmitted and received within the communications network (e.g., network 101). The signal records can include reports on performance, issues, timing information (e.g., start time of a phone call, end time of a phone call), length of a phone call, among other information captured within the communications network. The signals can be transmitted from at least one client device 115 to at least one cell 110. The signals can be transmitted between at least two client devices 115 and at least one cell 110. The signal record indexer 130 can obtain each of the signals from within the network 101 and to generate the record for storage within a database of the data center 105. In some instances, the signal record indexer 130 can provide the signal records to a plurality of servers associated with the data center 105. In some instances, the signal record indexer 130 can generate a user interface for display on one or more computing devices associated with the data center 105.

In some instances, the signal record indexer 130 can generate, identify, or otherwise create the signal records based on communications sessions within the network 101. For example, a client device 115A can initiate a communication (e.g., phone call, data transfer, web conference, etc.) with another client device 115B or computing device 120. A first cell 10A can detect the communication and capture information (e.g., signaling information) associated with the communication. The signaling information can include a source internet protocol (IP) address, a destination IP address, a session start time, protocol used, session end time, signal strength, frequency, etc. As the cell 110A captures the information associated with the communications session, the signal record indexer 130 can trigger the cell 110A to provide the signaling information to the data center 105. The signal record indexer 130 can store and analyze the signaling information to generate the signal record for the communications session. The signal record indexer 130 can repeat this process for each communications session within the network 101.

Each signal record can include one or more protocol data units (PDUs) corresponding to each communications session within the network 101. The one or more PDUs can be located within at least one of a physical layer, a data link layer, a network layer, a transport layer, or an application layer. The one or more PDUs can indicate how data (e.g., signaling information) is packaged and transmitted for a given communications session, anomalies of the data, sequence numbers, source addresses, destination addresses, among other call characteristics.

The session handler 135 can detect, identify, or otherwise indicate a signal record for a communications session between the client device 115 and the computing device 120. In some instances, the session handler 135 can detect, identify, or otherwise indicate a signal record for a communications session between one or more client devices 115. In some instances, the session handler 135 can detect, identify, or otherwise indicate a signal record for a communications session between the client device 115 and the data center 105. The session handler 135 can detect the signal record in response to an initiation of the communications session from the client device 115 or the cell 110. The initiation of the communications session can be based on a set of PDUs that correspond to indicate the detected signal record. In some instances, the session handler 135 can detect the communications session in response to an indication from the signal record indexer 130 or the data center 105. The communications session between two client device 115 can be a voice call, a video conference, an instant message, file transfer, email exchange, among other sessions. The communications session between at least one client device 115 and a computing device 120 can be web browsing, cloud storage access, database retrieval, software updates, among other sessions.

The session handler 135 can detect, identify, or otherwise indicate a cell handover of the first communications session from at least two cells 110. The cell handover can be at least one of a hard handover, a soft handover, or a seamless handover. For example, the session handler 135 can detect a seamless cell handover over a 5G network. The cell handover can occur as a client device 115 or computing device exits signal range of a first cell 110 and enters a signal range for another cell 110 during a communications session (e.g., phone call, data transfer). For example, a user can initiate a phone call through a client device 115 while driving on a highway. During the initiation of the phone call, the client device 115 can be in range of a first cell 110A at a first point in time. As the client device 115 moves along the highway, the client device 115 can exit the range of the first cell 110A and enter a range of a second cell 110B at second point in time, thereby causing a cell handover to occur. In this manner, the first cell 110A can generate a signal for transmission to the data center 105 indicating that the cell handover has occurred. The signal can include the time in which the handover occurred, the cell 110 in which the cell handover occurred with, the distance from the first cell 110A and the second cell 110B, among other information. The session handler 135 can be configured to receive the signal from the cell 110.

The session handler 135 can detect, identify, or otherwise indicate a communications end with at least one cell 110. The communications end can indicate or correspond to an end of a voice call, a video conference, an instant message, file transfer, email exchange, among others. The cell 110 hosting the communications session after the cell handover can generate signal to indicating the end of the communications session. For example, a cell handover can occur between a first cell 110A and a second cell 110B during a communications session with the client device 115. After a period of time, the client device 115 can terminate or end the communications session. The cell 110B can detect or identify the end of the communications session and generate a signal for transmission to the data center 105. The signal can indicate a duration of the communications session, the cells 110 involved in the communications session, the start of the communications session, and the end of the communications session.

The session handler 135 can determine, identity, or otherwise generate a timing advance (TA) for each period of the communications session as an average of TA values. The TA can be a parameter or a value to synchronize transmission or communications session timing of at least one client device 115 with at least one cell 110. The at least one client device 115 and the at least one cell 110 can use the TA to coordinate the transmission and reception of signals (e.g., video conferences, data transfers, etc.) The data center 105 or the session handler 135 can use the TA to determine how to improve synchronization of the client devices 115 and the cells 110, optimize network performance, and improve communication between the client devices 115 and the cells 110. The cell 110 can calculate, determine, or otherwise identify the TA value for a communications session if a cell handover does not occur. In some instance, the session handler 135 can calculate, determine, or otherwise identify the TA for the communication if the cell handover occurs. The cell 110 or the session handler 135 can measure a “round-trip” time of signals transmitted and received to the client device 115 or the cells 110 to form an average of the TA values. The cell 110 or the session handler 135 can calculate the TA based on the measurement to indicate an adjustment in the client devices 115 transmission timing for synchronization. From here, the cell 110 or the session handler 135 can provide the TA to the client device 115 thereby, causing the client device 115 to synchronize with the cell 110.

The communications session can include one or more periods that are separated by the cell handover. Each period can be established based on a number of cell handovers during a communications session. For example, the session handler 135 can detect a cell handover between a first cell 110A and a second cell 110B during a communications session at first time. The session handler 135 can establish a first period of the communications session as before the cell handover and establish a second period of the communications session as after the cell handover.

The function executer 140 can execute, apply, or otherwise perform a function on a first TA and a second TA. The function can be an algorithm that is executed to determine the first TA and the second TA for the respective periods of the communications session. The function can be represented as:

$$T A = \frac{1}{N} {\sum }_{i = 1}^{N} T {A}_{i}$$

In the function, TA can represent or correspond to timing advance (TA) and N can represent or correspond to the number of TA values. It is appreciated that despite two periods of the communications session are described herein, the technical solutions can be used for any number of periods of a communications session that correspond to any number of TAs (e.g., first TA, second TA, third TA, fourth TA, etc.). However, there are technical advantages of only using communications sessions that include a single handover between two cells of reducing differences in the morphology, area, or weather between the cells during a single communications session that may affect the determinations or quality of the communications session. The session handler 135 can trigger the function executer 140 to determine the TAs by executing the function. For example, the function executer 140 can execute the function to determine the first TA as an average of TA1 values during a first period of the communications session and prior to the cell handover. The function executer 140 can concurrently determine the second TA as an average of TA2 values during a second period of the communications session after the cell handover. The TA1 values and the TA2 values can correspond to the roundtrip time for a signal to travel from the client device 115A to the cell 110A or cell 110B and back to the client device 115A. In some instances, the function executer 140 can calculate the TA for the communications session by applying an operator (e.g., addition, subtraction, multiplication, or division) to the first TA and the second TA. In some cases, the first TA can be the TA when the communications session begins and the second TA can be the TA when the communications session ends. In some instances, the cells can provide the first TA and the second TA to the client device to facilitate the communications session (e.g., to ensure synchronized uplink/downlink transmission from the client device to the cells or base stations of the cells) such that the client device can use the TA to facilitate communication across the network. The client device and/or the cells can transmit or provide the TAs for the communications session to the data center.

In some instances, the function executer 140 can modify, adjust, or otherwise update the TAs (e.g., a first TA and a second TA) to correspond to a distance between the client device 115 and the first cell 110 or the second cell 110. The distance can correspond to the meters, miles, feet, yards, etc. between at least two cells 110. In some instances, the distance between the cells 110 is known by the data center 105 or the function executer 140. For example, the data center 105 can obtain the distance between a first cell 110B and a second cell 110C. In another example, the data center 105 can obtain a first distance between the first cell 110A and the second cell 110B and a second distance between the second cell 110B and a third cell 110C. The function executer 140 can use the function to update or adjust the TAs. For example, the function executer 140 can apply the distance and the speed of light to the function. Once applied, the function executer 140 can apply the sum of the first TA and the second TA to the function, thereby adjusting the first TA and the second TA based on the distance. The function can be represented as:

$$T A correction = \vert \frac{{D}_{ab} - \frac{c * ( {\sum }_{i = 1}^{N} T {A}_{i} )}{2 * 1 {0}^{9}}}{N * c} \vert$$

In the function, TA correction can represent the network synchronization offset, Dab can represent the distance between the towers of cells a and b, c can represent the speed of light, N can represent the number of cells 110 within the communication session, a can represent a start cell 110 in the communication session, and b can represent an end cell 110 in the communication session. The offset identifier 145 can determine, identify, or otherwise generate a network synchronization offset for the TA. The network synchronization offset can be a value, a metric, or a deviation that refers to a difference between the clocks of at least one cell 110 and at least one client device 116. A low network synchronization offset can indicate that the cell 110 and the client device 115 are synchronized, whereas a high synchronization offset can indicate the cell 110 and the client device 115 are not synchronized. The network synchronization offset can correspond to at least one of a time synchronization, a frequency synchronization, or a phase synchronization. Typically, conventional solutions can utilize global positioning systems (GPS) to determine the network synchronization offset, however, these suffer from accuracy issues because of signal delays, geographic conditions, multipath effects, clock drift, and other pitfalls. The systems and methods described herein avoid the use of GPS and determine the network synchronization offset using the TA instead. In this manner, the systems and method described herein can resolve accuracy issues from the GPS and ignore signal delays, geographic conditions, clock drift, and multipath effects.

Using the distance from the first cell 110 to the client device 115 and the distance from the second cell 110 to the client device 115, the offset identifier 145 can generate, determine, or otherwise identify the network synchronization offset. The offset identifier 145 can use the adjusted TA to determine the network synchronization offset. For example, the offset identifier 145 can apply an absolute value to the adjusted TA. From here, the offset identifier 145 can divide the adjusted TA by the number of cells involved in the communications session to determine the network synchronization offset. In some instances, the communications session can include three cells 110. In some instances, the communications session can only include two cells 110.

In some embodiments, the offset identifier 145 can transmit a signal to the data center 105 to adjust, modify, or otherwise change first cell or the second cell, in some cases based on an environmental factor for the cells 110. The signal can indicate the environmental factors to the data center 105. The environmental factors can include at least one of buildings, rural areas, trees, rain, snow, fog, microwaves, hills, valleys, mountains, water bodies, city congestion among other aspects of the environment that can degrade signals, increase interference, and reduce signal strength. The data center 105 can trigger the cells 110 to adjust at least one of power control, frequency allocation, load balancing, adaptive modulation and coding (AMC), antenna tilt and orientation, and interference coordination to adjust the cells 110.

The offset identifier 145 can determine a geolocation of the client device according to the distance between the cells 110 and the client device 115. In some instances, the offset identifier 145 can determine the geolocation by using at least one of cell triangulation, the cell IDs, time difference of arrive (TDOA), angle of arrival (AOA), Wi-Fi positioning, cellular data positioning, among others. For example, as the client device 115 is traveling along a highway between two cells 110 (e.g., cell 110A, cell 110B). The cells 110 can use the distance between the cells 110 for cell triangulation to identify signal strength and the timing advance to determine the geolocation of the client device 115.

The offset identifier 145 can transmit a signal to the data center 105 to adjust, modify, or otherwise change the cells 110 according to the network synchronization offset. The signal can indicate the network synchronization offset for the data center 105. The adjustment to the cells 110 can correspond to an adjustment to one or more antennas associated with the cells 110 in the communication session. For example, the signal can include a tilt and orientation for the one or more antennas. The tilt and orientation can be determined based on the TA correction value to improve signal quality associated with the communication session. For instance, the change in tilt or orientation can be proportional to the determined TA correction values. In some instances, the tilt and orientation can be based on the distance to the client device or the computing device. In some instances, the cells 110 can use phase shifters of the antennas to adjust the phase and timing of signals that are transmitted and received. In this manner the one or more antennas can change a direction of a beam to optimize the communication session. In some instances, the offset identifier 145 can compare the network synchronization offset to a threshold. The threshold can correspond to the tilt and orientation of the one or more antennas. The offset identifier 145 can adjust the tilt and orientation of the one or more antennas in response to determining that the network synchronization offset does not satisfy the threshold. In some instances, the tilt and orientation can be adjusted proportional to the network synchronization offset or a difference between the network synchronization offset and the threshold.

In another example, the data center 105 can provide the network offset synchronization offset to each cell 110 involved in the communications session. The cells 110 can provide the network synchronization offset to the client device 115. The detection of the network synchronization offset can cause or trigger the client device 115 to adjust its transmission timing to reduce interference and enhance communication between the cells. The network synchronization offset at the client device 115 can adjust the timing advance by a minimal delta. In some instance, the network synchronization offset can adjust the timing advance by a large delta. In the presence of the cell handover, the target cell 110 (e.g., cell 110B) can transmit the network synchronization offset to adjust the timing advance of the client device 115 for the period of the communications session after the cell handover.

The offset identifier 145 can determine an updated geolocation by applying the network synchronization offset to the geolocation. The updated geolocation can be more precise than the geolocation. The offset identifier 145 can apply the network synchronization offset via triangulation by using the network synchronization offset for the communications session. In some instances, the offset identifier 145 can re-calculate the geolocation by using the network synchronization offset as the client device 115 moves between two cells 110.

In this manner the systems and methods described herein can improve on conventional solutions by determining a network synchronization offset (e.g., timing advance correction value) without the use of GPS data or MDT data. By avoiding the use of these computationally expensive methods, the systems and methods described herein can save bandwidth, reduce latency, and increase client device accuracy, and providing readily accessible implementations in real time (or near real time). Furthermore, the systems and methods described herein can improve mobility scenarios associated with cell handover.

The record generator 150 can generate, create, or otherwise determine a record. The record can identify a geolocation of a second client device 115B participating in a second communications session through the first cell 110A or the second cell 110B based on the network synchronization offset. The record can include a start cell 110 or eNodeB (e.g., first cell 110A), an end cell 110 or eNodeB (e.g., second cell 110B), an S1 release cause, reference signal received power (RSRP), reference signal received quality (RSRQ), among other information. The record generator 150 can store the record within a database associated with the data center 105. In some instances, the record can be provided to the computing device 120. The record can indicate each communications session within the network 101 between a plurality of cells 110.

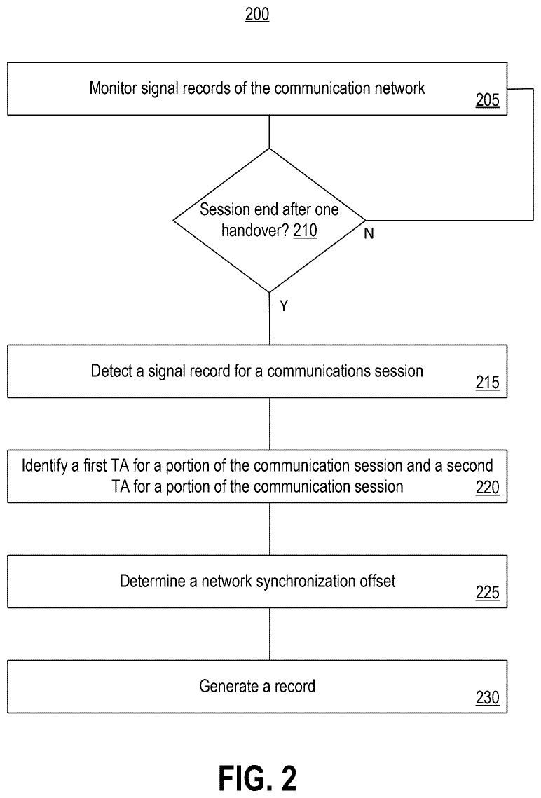

FIG. 2 is an illustration of a method 200 for the correction of timing advance estimations. The method 200 can be perfumed by the components of the system 100 (e.g., data center 105, cells 110, data processing system 125, among others). At step 205, a data center can monitor signal records of the communication network. At step 210, the data center can determine whether the communications session ends after a first cell handover. At step 215, the data center can detect a signal record for a communications session. At step 220, the data center can identify a first TA for a period of the communications session and a second TA for a period of the communications session. At step 225, the data center can determine a network synchronization offset. At step 230, the data center can generate a record based on the network synchronization offset.

At step 205, the data center can monitor signal records of the communication network. The signal records can include one or more protocol data units (PDUs) corresponding to each communications session between client devices and computing devices within the network. In some instances, the communications session can be between one or more client devices. In some instances, the communications session can be between one or more computing devices.

At step 210, the data center can determine whether the communications session ends after a first cell handover. The data center can detect that the communication ends in response to an indication an end of the communications session from the second cell of the communications session. Responsive to determining the communications session ends after one cell handover, the method 200 can proceed to step 215. Otherwise, the method 200 can return to step 205.

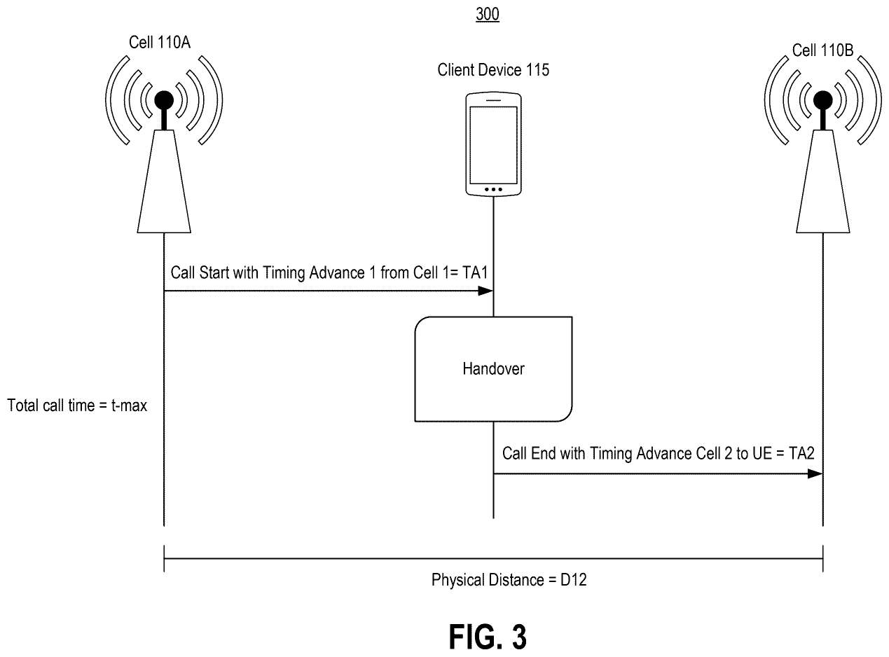

At step 215, the data center can detect a signal record for the detected communications session. The communications session can be between the client device and the computing devices based on the signal record. For example, a set of PDUs can indicate that the communications session is initiated through a first cell. As the client device travels, a handover can occur between a first cell and a second cell. The first call and the second cell can be a base station (BS). The base station can be an eNodeB BS. FIG. 3 is an illustration of a block diagram of a process 300 for cell handovers during a communications session. The first cell 110A can initiate the communications session and the second cell 110B can terminate the communications session. The handover can occur as the cell is within range of the second cell 110B and leaves the range of the first cell 110A. The distance between the client device and the cells can be measured throughout the communications session.

By only using communications sessions that end after a single handover, the data center can ensure a higher level of accuracy and reduce the processing time compared to using communications sessions with multiple handovers. For example, as shown in FIG. 3, a call may be started and then handed over to another cell with call termination in a relatively short period of time (t-max) such as less than 10 seconds. Here, the start and end of the call will result in TA provided by the network to UE and as the distance is known since cell tower latitude and longitude may be known, thus the data center can calculate the actual TA delta or synchronization offset. Since the two cells are in the same morphology or area, it can be assumed that same TA delta or synchronization offset is applied, thus the net result can be averaged or divided by two.

In one example, the data center can identify the record of the communications session by applying a set of criteria. For instance, the criteria may be that the communications session begins in one cell, is handed over to another cell, and then ends in that other cell, for example. In some cases, the criteria may further require that the communications session end within a set time period. Such criteria may ensure that the same TA delta or synchronization offset is applied throughout the communications session, for example. The data center can receive and monitor records for communication sessions over time, applying the set of criteria to the PDUs contained in each of the records. Based on the monitoring, the data center can identify a record for the communications session between the client device and the computing device based on the communications satisfying the set of criteria.

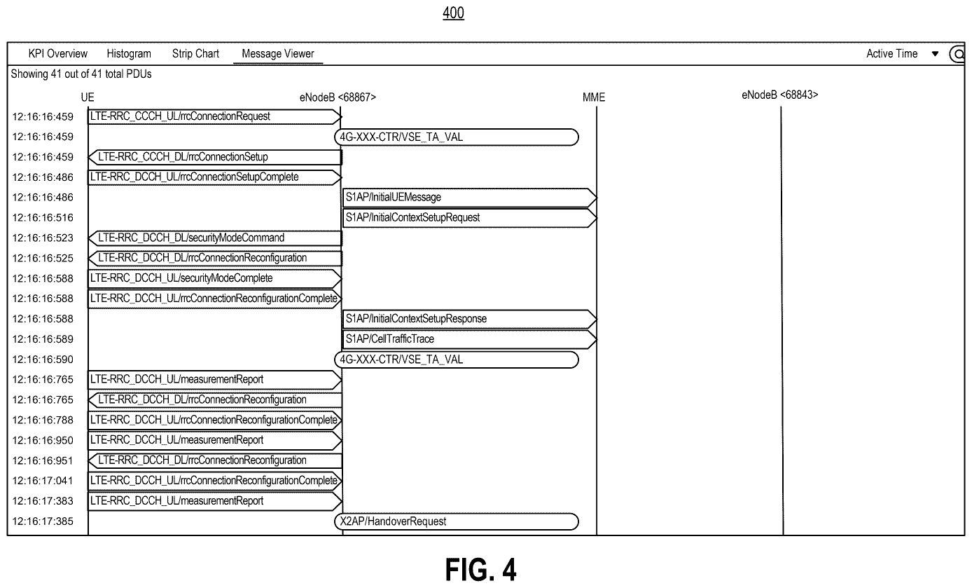

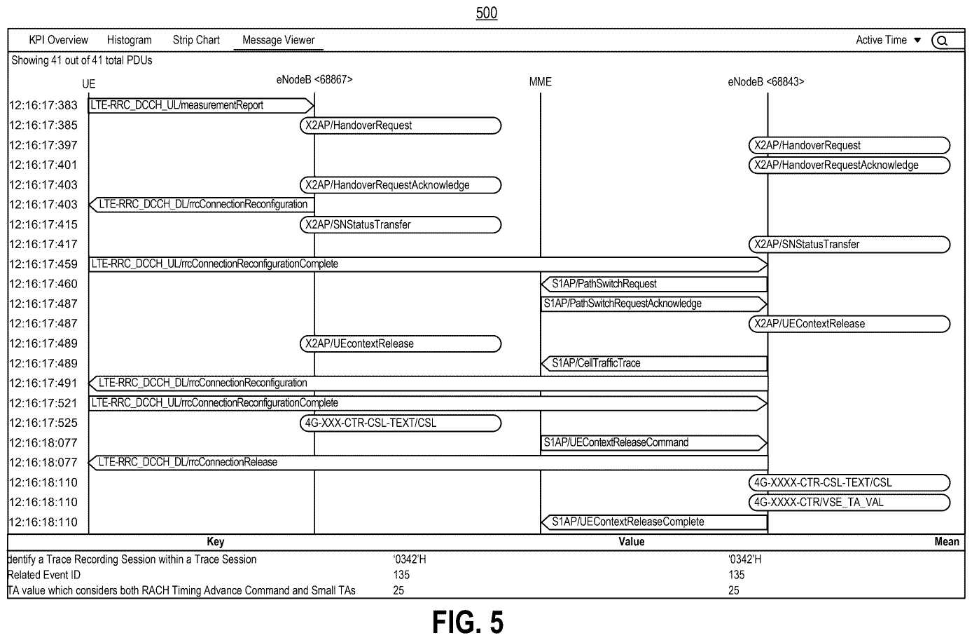

At step 220, the data center can identify a first TA for a period of the communications session between the client device and the computing device and a second TA for a period of the communications session. A first period of the communications session can be through a first cell and a second period of the communications session can be through a second cell after the handover from the first cell to the second cell. FIG. 4 is an example of a call trace scenario 400 during the communications session. The call trace scenario 400 can indicate a plurality of signals, messages, and other notifications transmitted between a client device or computing device and the cells before and after the cell handover. FIG. 5 is another example of a call trace scenario 500 during the communications session. In the call trace scenarios, a call starting and ending with TA and then an intermediate HO messages can have a bandwidth 12:16:16:459 to 12:16:18:110 with a TA that is present from both the eNodeBs 68867 and 68643 within a few seconds of proximity of handover. The data center can determine the first TA as an average of TA1 values during the first period of the communications session. The data center can determine the second TA as an average of TA2 values during the second period of the communications session. In some cases, the first and second cells may respectively provide the timing advance that they are using for the communications to the client device and/or the data center.

At step 225, the offset identifier can determine a network synchronization offset. The network synchronization offset can be determined as a function of the first TA and the second TA. To determine the network synchronization offset, the data center can use a first function to modify the first TA to correspond to a first distance between the client device and the first cell and modify the second TA to correspond to a second distance between the client device and the second cell. From here, the data center can use an aggregation function on the first distance and the second distance to generate a third distance. The data center can generate the network synchronization offset by executing a correction function on the third distance. In some instances, the data center can determine a network synchronization offset as a function of the third TA and the fourth TA. An example of a combination of the aggregation function and the correction function to determine a TA correction or network synchronization offset is below:

$$T A correction = \vert \frac{{D}_{ab} - \frac{c * ( {\sum }_{i = 1}^{N} T {A}_{i} )}{2 * 1 {0}^{9}}}{N * c} \vert$$

Where TA correction can represent the network synchronization offset, Dab can represent the distance between the towers of cells a and b, c can represent the speed of light, N can represent the number of cells within the communication session, a can represent a start cell in the communication session, and b can represent an end cell in the communication session.

Using the network synchronization offset, the data center can adjust the first cell and/or the second cell based on the network synchronization offset. The data center can further adjust the first cell and/or the second cell based on the environmental factors impacting each cell in the network. The data center can determine an updated geo-location of the client device by applying the network synchronization offset to correct an initial geo-location of the client device. In this manner, the data center can improve an accuracy of the initial geo-location without global positioning system (GPS) data. The data center can store the network synchronization offset in memory, in some cases with an indication of the first and second cells. The indications can be to use the network synchronization offset to determine locations of devices within the first and second cells and/or to otherwise facilitate communications sessions with devices connected with the first and second cells using the network synchronization offset. The data center can similarly determine network synchronization offsets for any number of pairs of cells using communications sessions that start in one cell and end in another cell after one handover.

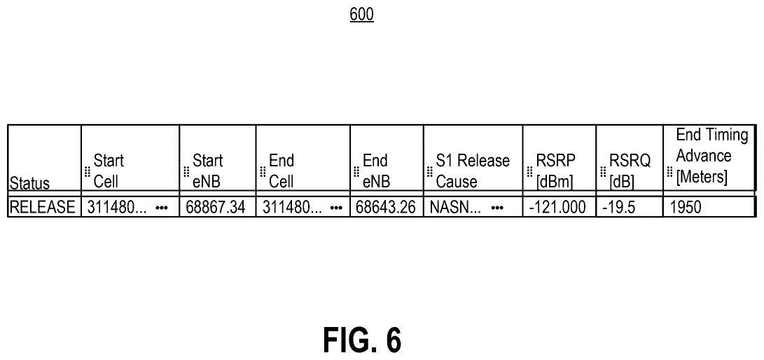

At step 230, the data center can generate a record based on the network synchronization offset. The data center can generate the record based on the network synchronization offset by using the synchronization offset to determine a geolocation of another client device associated with a communications session within the first and/or second cells. For instance, the data center can identify a communications session between a second client device another computing device or the same computing device as the initial communications session in which the second client device is connected or located within the first cell and/or the second cell during the communications session. The data center can identify the locations or connected cell of the second communications session as the first and second cell and identify the indication determined network synchronization offset for the first and second cell. The data center can use the network synchronization offset to determine the geographic location of the second client device throughout the second communications session. The data center can generate a record in memory identifying the location or locations of the second client device in memory. FIG. 6 is an example record 600 generated using the correction of the timing advance correction.

In some cases, the data center can dynamically update the synchronization offsets for communications sessions occurring within different cells. For example, after determining the synchronization offset for the first and the second cell using the systems and method described herein, the data center can identify or detect a second signal record for another communications session that begins in the second cell and ends after a single handover to a third cell. The data center can do so based on a second set of PDUs included in the second signal record, as described herein. The data center can identify the second signal record by performing the steps 205 and 210, for example. The data processing system can then perform steps 215-225 to determine a network synchronization offset 225 for the second and third cell, updating the network synchronization offset previously determined for the second cell. For instance, the data center can identify a third TA for a period of the second communications session through the second cell and a fourth TA for a period of the second communications session end through the third cell after the handover from the second cell to the third cell. The data center can determine a second network synchronization offset as a function of the third TA and the fourth TA using the systems and methods described herein. The data center can then use the second network synchronization offset to identify a second geolocation of a fourth client device participating in a third communications session through the second cell or the third cell based on the second network synchronization offset. The data center can repeat this process for any number of pairs of cells and/or communications sessions. In this way, the data center can maintain a real-time view of the synchronization offsets accounting for differences in geographic locations, changes over time within specific geographic locations, and specific characteristics of communications sessions occurring within pairs of adjacent cells to maintain and increasingly determine accurate synchronization offsets for the individual cells.

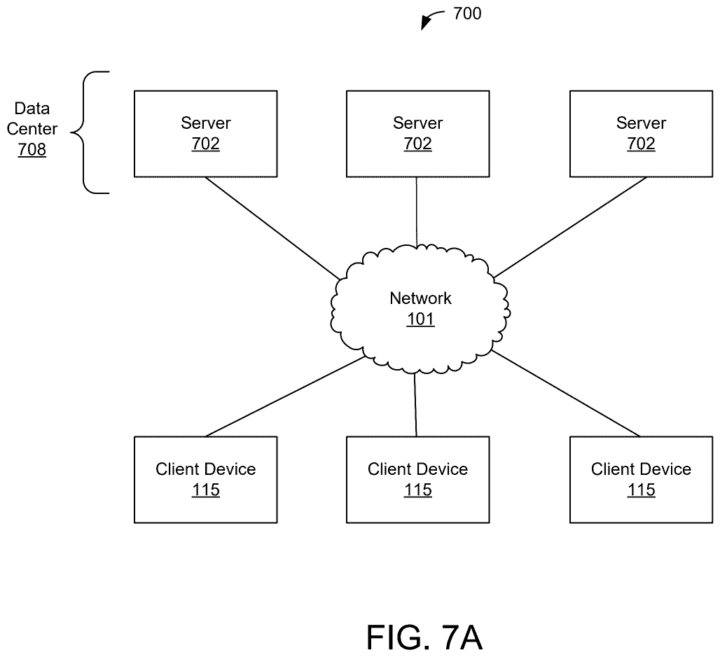

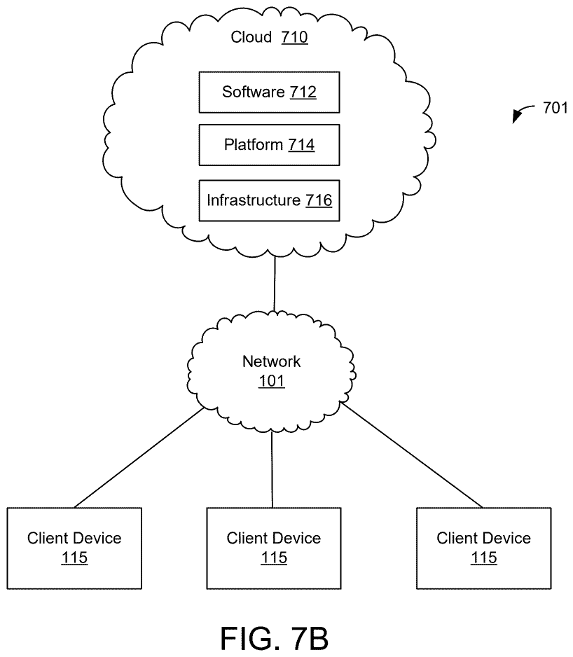

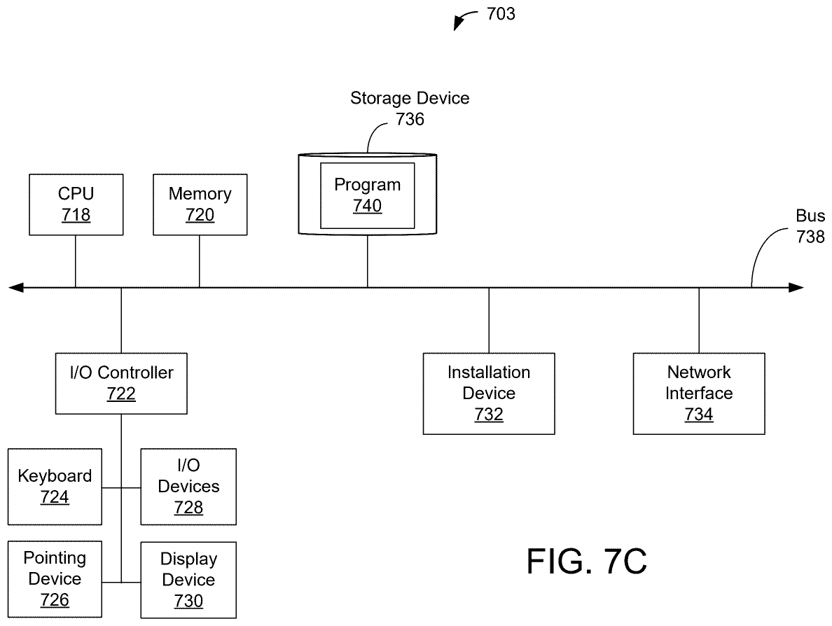

FIG. 7A depicts an example network environment that can be used in connection with the methods and systems described herein. In brief overview, the network environment 700 includes one or more client devices 115 (also generally referred to as clients, client node, client machines, client computers, client computing devices, endpoints, or endpoint nodes) in communication with one or more servers 702 (also generally referred to as servers, nodes, or remote machine) via one or more networks 101. In some embodiments, a client 115 has the capacity to function as both a client node seeking access to resources provided by a server and as a server providing access to hosted resources for other client devices 115.

Although FIG. 7A shows a network 101 between the client devices 115 and the servers 702, the client devices 115 and the servers 702 can be on the same network 101. In embodiments, there are multiple networks 101 between the client devices 115 and the servers 702. The network 101 can include multiple networks such as a private network and a public network. The network 101 can include multiple private networks.

The network 101 can be connected via wired or wireless links. Wired links can include Digital Subscriber Line (DSL), coaxial cable lines, or optical fiber lines. The wireless links can include BLUETOOTH, Wi-Fi, Worldwide Interoperability for Microwave Access (WiMAX), an infrared channel or satellite band. The wireless links can also include any cellular network standards used to communicate among mobile devices, including standards that qualify as 1G, 2G, 3G, 4G, 5G or other standards. The network standards can qualify as one or more generation of mobile telecommunication standards by fulfilling a specification or standards such as the specifications maintained by International Telecommunication Union. Examples of cellular network standards include AMPS, GSM, GPRS, UMTS, LTE, LTE Advanced, Mobile WiMAX, and WiMAX-Advanced. Cellular network standards can use various channel access methods e.g., FDMA, TDMA, CDMA, or SDMA. In some embodiments, different types of data can be transmitted via different links and standards. In other embodiments, the same types of data can be transmitted via different links and standards.

The network 101 can be any type and/or form of network. The geographical scope of the network 101 can vary widely and the network 101 can be a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can be an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol or the internet protocol suite (TCP/IP). The TCP/IP internet protocol suite can include application layer, transport layer, internet layer (including, e.g., IPv6), or the link layer. The network 101 can be a type of a broadcast network, a telecommunications network, a data communication network, or a computer network.

The network environment 700 can include multiple, logically grouped servers 702. The logical group of servers can be referred to as a data center 708 (or server farm or machine farm). In embodiments, the servers 702 can be geographically dispersed. The data center 708 can be administered as a single entity or different entities. The data center 708 can include multiple data centers 708 that can be geographically dispersed. The servers 702 within each data center 708 can be homogeneous or heterogeneous (e.g., one or more of the servers 702 or machines 702 can operate according to one type of operating system platform (e.g., WINDOWS NT, manufactured by Microsoft Corp. of Redmond, Washington), while one or more of the other servers 702 can operate on according to another type of operating system platform (e.g., Unix, Linux, or Mac OS X)). The servers 702 of each data center 708 do not need to be physically proximate to another server 702 in the same machine farm 708. Thus, the group of servers 702 logically grouped as a data center 708 can be interconnected using a network. Management of the data center 708 can be de-centralized. For example, one or more servers 702 can comprise components, subsystems and modules to support one or more management services for the data center 708.

Server 702 can be a file server, application server, web server, proxy server, appliance, network appliance, gateway, gateway server, virtualization server, deployment server, SSL VPN server, or firewall. In embodiments, the server 702 can be referred to as a remote machine or a node. Multiple nodes can be in the path between any two communicating servers.

FIG. 7B illustrates an example cloud computing environment. A cloud computing environment 701 can provide client 115 with one or more resources provided by a network environment. The cloud computing environment 701 can include one or more client devices 115, in communication with the cloud 710 over one or more networks 101. Client devices 115 can include, e.g., thick clients, thin clients, and zero clients. A thick client can provide at least some functionality even when disconnected from the cloud 710 or servers 702. A thin client or a zero client can depend on the connection to the cloud 710 or server 702 to provide functionality. A zero client can depend on the cloud 710 or other networks 101 or servers 702 to retrieve operating system data for the client device. The cloud 710 can include back-end platforms, e.g., servers 702, storage, server farms or data centers.

The cloud 710 can be public, private, or hybrid. Public clouds can include public servers 702 that are maintained by third parties to the client devices 115 or the owners of the clients. The servers 702 can be located off-site in remote geographical locations as disclosed above or otherwise. Public clouds can be connected to the servers 702 over a public network. Private clouds can include private servers 702 that are physically maintained by client devices 115 or owners of clients. Private clouds can be connected to the servers 702 over a private network 101. Hybrid clouds 708 can include both the private and public networks 101 and servers 702.

The cloud 710 can also include a cloud-based delivery, e.g., Software as a Service (Saas) 712, Platform as a Service (PaaS) 714, and the Infrastructure as a Service (IaaS) 716. IaaS can refer to a user renting the use of infrastructure resources that are needed during a specified time period. IaaS providers can offer storage, networking, servers or virtualization resources from large pools, allowing the users to quickly scale up by accessing more resources as needed. PaaS providers can offer functionality provided by IaaS, including, e.g., storage, networking, servers or virtualization, as well as additional resources such as, e.g., the operating system, middleware, or runtime resources. SaaS providers can offer the resources that PaaS provides, including storage, networking, servers, virtualization, operating system, middleware, or runtime resources. In some embodiments, SaaS providers can offer additional resources including, e.g., data and application resources.

Client devices 115 can access IaaS resources, SaaS resources, or PaaS resources. In embodiments, access to IaaS, PaaS, or SaaS resources can be authenticated. For example, a server or authentication server can authenticate a user via security certificates, HTTPS, or API keys. API keys can include various encryption standards such as, e.g., Advanced Encryption Standard (AES). Data resources can be sent over Transport Layer Security (TLS) or Secure Sockets Layer (SSL).

The client 115 and server 702 can be deployed as and/or executed on any type and form of computing device, e.g., a computer, network device or appliance capable of communicating on any type and form of network and performing the operations described herein.

FIG. 7C depicts block diagrams of a computing device 702 useful for practicing an embodiment of the client 115 or a server 702. As shown in FIG. 7C, each computing device 702 can include a central processing unit 718, and a main memory unit 720. As shown in FIG. 7C, a computing device 702 can include one or more of a storage device 736, an installation device 732, a network interface 734, an I/O controller 722, a display device 730, a keyboard 724 or a pointing device 726, e.g., a mouse. The storage device 736 can include, without limitation, a program 740, such as an operating system, software, or software associated with system 100.

The central processing unit 718 is any logic circuitry that responds to and processes instructions fetched from the main memory unit 720. The central processing unit 718 can be provided by a microprocessor unit, e.g.: those manufactured by Intel Corporation of Mountain View, California. The computing device 702 can be based on any of these processors, or any other processor capable of operating as described herein. The central processing unit 718 can utilize instruction level parallelism, thread level parallelism, different levels of cache, and multi-core processors. A multi-core processor can include two or more processing units on a single computing component.

Main memory unit 720 can include one or more memory chips capable of storing data and allowing any storage location to be directly accessed by the microprocessor 718. Main memory unit 720 can be volatile and faster than storage 736 memory. Main memory units 720 can be Dynamic random-access memory (DRAM) or any variants, including static random access memory (SRAM). The memory 720 or the storage 736 can be non-volatile; e.g., non-volatile read access memory (NVRAM). The memory 720 can be based on any type of memory chip, or any other available memory chips. In the example depicted in FIG. 7C, the processor 718 can communicate with memory 720 via a system bus 738.

A wide variety of I/O devices 728 can be present in the computing device 702. Input devices 728 can include keyboards, mice, trackpads, trackballs, touchpads, touch mice, multi-touch touchpads and touch mice, microphones, multi-array microphones, drawing tablets, cameras, or other sensors. Output devices can include video displays, graphical displays, speakers, headphones, or printers.

I/O devices 728 can have both input and output capabilities, including, e.g., haptic feedback devices, touchscreen displays, or multi-touch displays. Touchscreen, multi-touch displays, touchpads, touch mice, or other touch sensing devices can use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices can allow two or more contact points with the surface, allowing advanced functionality including, e.g., pinch, spread, rotate, scroll, or other gestures. Some touchscreen devices, including, e.g., Microsoft PIXELSENSE or Multi-Touch Collaboration Wall, can have larger surfaces, such as on a table-top or on a wall, and can also interact with other electronic devices. Some I/O devices 728, display devices 730 or group of devices can be augmented reality devices. The I/O devices can be controlled by an I/O controller 722 as shown in FIG. 7C. The I/O controller 722 can control one or more I/O devices, such as, e.g., a keyboard 724 and a pointing device 726, e.g., a mouse or optical pen. Furthermore, an I/O device can also provide storage and/or an installation device 732 for the computing device 702. In embodiments, the computing device 702 can provide USB connections (not shown) to receive handheld USB storage devices. In embodiments, an I/O device 728 can be a bridge between the system bus 738 and an external communication bus, e.g., a USB bus, a SCSI bus, a FireWire bus, an Ethernet bus, a Gigabit Ethernet bus, a Fibre Channel bus, or a Thunderbolt bus.

In embodiments, display devices 730 can be connected to I/O controller 722. Display devices can include, e.g., liquid crystal displays (LCD), electronic papers (e-ink) displays, flexile displays, light emitting diode displays (LED), or other types of displays. In some embodiments, display devices 730 or the corresponding I/O controllers 722 can be controlled through or have hardware support for OPENGL or DIRECTX API or other graphics libraries. Any of the I/O devices 728 and/or the I/O controller 722 can include any type and/or form of suitable hardware, software, or combination of hardware and software to support, enable or provide for the connection and use of one or more display devices 730 by the computing device 702. For example, the computing device 702 can include any type and/or form of video adapter, video card, driver, and/or library to interface, communicate, connect or otherwise use the display devices 730. In embodiments, a video adapter can include multiple connectors to interface to multiple display devices 730.

The computing device 702 can include a storage device 736 (e.g., one or more hard disk drives or redundant arrays of independent disks) for storing an operating system or other related software, and for storing application software programs 740 such as any program related to the systems, methods, components, modules, elements, or functions depicted in FIG. 1, or 2. Examples of storage device 736 include, e.g., hard disk drive (HDD); optical drive including CD drive, DVD drive, or BLU-RAY drive; solid-state drive (SSD); USB flash drive; or any other device suitable for storing data. Storage devices 736 can include multiple volatile and non-volatile memories, including, e.g., solid state hybrid drives that combine hard disks with solid state cache. Storage devices 736 can be non-volatile, mutable, or read-only. Storage devices 736 can be internal and connect to the computing device 702 via a bus 738. Storage device 736 can be external and connect to the computing device 702 via an I/O device 730 that provides an external bus. Storage device 736 can connect to the computing device 702 via the network interface 734 over a network 101. Some client devices 115 may not require a non-volatile storage device 736 and can be thin clients or zero client devices 115. Some storage devices 736 can be used as an installation device 732 and can be suitable for installing software and programs.

The computing device 702 can include a network interface 734 to interface to the network 101 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). The computing device 702 can communicate with other computing devices 702 via any type and/or form of gateway or tunneling protocol e.g. Secure Socket Layer (SSL) or Transport Layer Security (TLS), QUIC protocol, or the Citrix Gateway Protocol manufactured by Citrix Systems, Inc. of Ft. Lauderdale, Florida. The network interface 734 can include a built-in network adapter, network interface card, PCMCIA network card, EXPRESSCARD network card, card bus network adapter, wireless network adapter, USB network adapter, modem or any other device suitable for interfacing the computing device 702 to any type of network capable of communication and performing the operations described herein.

A computing device 702 of the sort depicted in FIG. 7C can operate under the control of an operating system, which controls scheduling of tasks and access to system resources. The computing device 702 can be running any operating system configured for any type of computing device, including, for example, a desktop operating system, a mobile device operating system, a tablet operating system, or a smartphone operating system.

The computing device 702 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computing device 702 has sufficient processor power and memory capacity to perform the operations described herein. In some embodiments, the computing device 702 can have different processors, operating systems, and input devices consistent with the device.

In embodiments, the status of one or more machines 702 in the network 101 can be monitored as part of network management. In embodiments, the status of a machine can include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information can be identified by a plurality of metrics, and the plurality of metrics can be applied at least in part towards decisions in load distribution, network traffic management, and network failure recovery as well as any aspects of operations of the present solution described herein.

The processes, systems and methods described herein can be implemented by the computing device 702 in response to the CPU 718 executing an arrangement of instructions contained in main memory 720. Such instructions can be read into main memory 720 from another computer-readable medium, such as the storage device 736. Execution of the arrangement of instructions contained in main memory 720 causes the computing device 702 to perform the illustrative processes described herein. One or more processors in a multi-processing arrangement may also be employed to execute the instructions contained in main memory 720. Hard-wired circuitry can be used in place of or in combination with software instructions together with the systems and methods described herein. Systems and methods described herein are not limited to any specific combination of hardware circuitry and software.

Although an example computing system has been described in FIGS. 7A-7C, the subject matter including the operations described in this specification can be implemented in other types of digital electronic circuitry, or in computer software, firmware, or hardware, including the structures disclosed in this specification and their structural equivalents, or in combinations of one or more of them.

Aspects of the technical solutions described herein relate to a method for correcting a timing advance (TA) in a communication network. The method can include monitoring, by one or more processors, signal records of the communications network each including one or more protocol data units (PDUs) of a different communications session between client devices and computing devices over the communications network; detecting, by the one or more processors based on the monitoring, a signal record for a communications session between a first client device and a computing device based on the signal record including a set of PDUs indicating a first communications session initiation through a first cell, a handover of the first communications session from the first cell to a second cell, and a communications session end at the second cell; identifying, by the one or more processors, a first TA for a period of the first communications session through the first cell and a second TA for a period of the first communications session end through the second cell after the handover from the first cell to the second cell; determining, by the one or more processors, a network synchronization offset as a function of the first TA and the second TA; and generating, by the one or more processors, a record identifying a geolocation of a second client device participating in a second communications session through the first cell or the second cell based on the network synchronization offset.

The method can further include adjusting, by the one or more processors, the first cell or the second cell according to the network synchronization offset. The method can further include adjusting, by the one or more processors, the first cell or the second based on an environmental factor for the first cell or the second cell. Determining the network synchronization offset can further include modifying, by the one or more processors using a first function, the first TA to correspond to a first distance; modifying, by the one or more processors using the first function, the second TA to correspond to a second distance; and generating, by the one or more processors using an aggregation function on the first distance and the second distance, a third distance.

The method can further include generating, by the one or more processors, the network synchronization offset by executing a correction function on the third distance. The method can further include determining, by the one or more processors, an updated geo-location of the client device by applying the network synchronization offset to correct an initial geo-location of the client device to improve an accuracy of the initial geo-location without global positioning system (GPS) data. The first cell and the second cell can each be a base station (BS). The BS can be an eNodeB BS. The method can further include determining, by the one or more processors, the first TA as an average of TA1 values during the first period of the communications session; and determining, by the one or more processors, the second TA as an average of TA2 values during the second period of the communications session.

The method can further include detecting, by the one or more processors based on the monitoring, a second signal record for a communications session between a third client device and the computing device based on the second signal record including a set of PDUs indicating a second communications session initiation through the second cell, a handover of the second communications session from the second cell to a third cell, and communications session end at the third cell; identifying, by the one or more processors, a third TA for a period of the second communications session through the second cell and a fourth TA for a period of the second communications session end through the third cell after the handover from the second cell to the third cell; determining, by the one or more processors, a second network synchronization offset as a function of the third TA and the fourth TA; and generating, by the one or more processors, a second record identifying a second geolocation of a fourth client device participating in a third communications session through the second cell or the third cell based on the second network synchronization offset. A distance for the first cell and the second cell can be based on a latitude and longitude of each cell (e.g., the distance can be determined using a distance function between the latitude and longitudes of the towers of each cell).

Aspects of the technical solutions described herein relate to a system. The system can include one or more processors coupled with memory. The one or more processors can be configured to monitor signal records of the communications network each including one or more protocol data units (PDUs) of a different communications session between client devices and computing devices over the communications network. The one or more processors can be configured to detect, based on the monitoring, a signal record for a communications session between a first client device and a computing device based on the signal record including a set of PDUs indicating a first communications session initiation through a first cell, handover of the first communications session from the first cell to a second cell, and communications session end at the second cell. The one or more processors can be configured to identify a first TA for a period of the first communications session through the first cell and a second TA for a period of the first communications session end through the second cell after the handover from the first cell to the second cell. The one or more processors can be configured to determine a network synchronization offset as a function of the first TA and the second TA. The one or more processors can be configured to generate a record identifying a geolocation of a second client device participating in a second communications session through the first cell or the second cell based on the network synchronization offset.

The one or more processors can be configured to adjust the first cell or the second cell according to the network synchronization offset. The one or more processors can be configured to adjust the first cell or the second based on an environmental factor for the first cell or the second cell. The one or more processors can be configured to modify, using a first function, the first TA to correspond to a first distance. The one or more processors can be configured to modify, using the first function, the second TA to correspond to a second distance. The one or more processors can be configured to generate, using an aggregation function on the first distance and the second distance, a third distance.

The one or more processors can be configured to generate the network synchronization offset by executing a correction function on the third distance. The one or more processors can be configured to determine an updated geo-location of the client device by applying the network synchronization offset to correct an initial geo-location of the client device to improve an accuracy of the updated geo-location without global positioning system (GPS) data.

The first cell and the second cell can be a base station (BS), wherein the BS is an eNodeB BS. The one or more processors can be configured to determine the first TA as an average of TA1 values during the first period of the communications session. The one or more processors can be configured to determine the second TA as an average of TA2 values during the second period of the communications session.

The one or more processors can be configured to detect, based on the monitoring, a second signal record for a communications session between a third client device and the computing device based on the second signal record including a set of PDUs indicating a second communications session initiation through the second cell, a handover of the second communications session from the second cell to a third cell, and communications session end at the third cell. The one or more processors can be configured to identify a third TA for a period of the second communications session through the second cell and a fourth TA for a period of the second communications session end through the third cell after the handover from the second cell to the third cell. The one or more processors can be configured to determine a second network synchronization offset as a function of the third TA and the fourth TA. The one or more processors can be configured to generate a second record identifying a second geolocation of a fourth client device participating in a third communications session through the second cell or the third cell based on the second network synchronization offset.

The foregoing detailed description includes illustrative examples of various aspects and embodiments and provides an overview or framework for understanding the nature and character of the claimed aspects and embodiments. The drawings provide illustration and a further understanding of the various aspects and embodiments and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “computing device” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a period of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs (e.g., components of the data processing system 125) to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all embodiments, and the described program components can be included in a single hardware or software product.

The phraseology and terminology used herein is for the purpose of description and should not be regarded as limiting. Any references to embodiments or elements or acts of the systems and methods herein referred to in the singular may also embrace embodiments including a plurality of these elements, and any references in plural to any implementation or element or act herein may also embrace embodiments including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A,’ only ‘B,’ as well as both ‘A’ and ‘B.’ Such references used in conjunction with “comprising” or other open terminology can include additional items.

The foregoing embodiments are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. A method for correcting a timing advance (TA) in a communication network, comprising:
monitoring, by one or more processors, signal records of the communications network each including one or more protocol data units (PDUs) of a different communications session between client devices and computing devices over the communications network;
detecting, by the one or more processors based on the monitoring, a signal record for a communications session between a first client device and a computing device based on the signal record including a set of PDUs indicating a first communications session initiation through a first cell, a handover of the first communications session from the first cell to a second cell, and a communications session end at the second cell;
identifying, by the one or more processors, a first TA for a first period of the first communications session through the first cell and a second TA for a second period of the first communications session end through the second cell after the handover from the first cell to the second cell;
determining, by the one or more processors, a network synchronization offset as a function of the first TA and the second TA; and
generating, by the one or more processors, a record identifying a geolocation of a second client device participating in a second communications session through the first cell or the second cell based on the network synchronization offset.

2. The method of claim 1, further comprising:
adjusting, by the one or more processors, the first cell or the second cell according to the network synchronization offset.

3. The method of claim 2, further comprising:
adjusting, by the one or more processors, the first cell or the second based on an environmental factor for the first cell or the second cell.

4. The method of claim 1, wherein determining the network synchronization offset further comprises:
modifying, by the one or more processors using a first function, the first TA to correspond to a first distance;
modifying, by the one or more processors using the first function, the second TA to correspond to a second distance; and
generating, by the one or more processors using an aggregation function on the first distance and the second distance, a third distance.

5. The method of claim 4, further comprising:
generating, by the one or more processors, the network synchronization offset by executing a correction function on the third distance.

6. The method of claim 1, further comprising:
determining, by the one or more processors, an updated geo-location of the first client device by applying the network synchronization offset to correct an initial geo-location of the first client device to improve an accuracy of the initial geo-location without global positioning system (GPS) data.

7. The method of claim 1, wherein the first cell and the second cell are a base station (BS), and wherein the BS is an eNodeB BS.

8. The method of claim 1, further comprising:
determining, by the one or more processors, the first TA as an average of TA1 values during the first period of the communications session; and
determining, by the one or more processors, the second TA as an average of TA2 values during the second period of the communications session.

9. The method of claim 1, further comprising:
detecting, by the one or more processors based on the monitoring, a second signal record for a communications session between a third client device and the computing device based on the second signal record including a set of PDUs indicating a second communications session initiation through the second cell, a handover of the second communications session from the second cell to a third cell, and communications session end at the third cell;
identifying, by the one or more processors, a third TA for a third period of the second communications session through the second cell and a fourth TA for a fourth period of the second communications session end through the third cell after the handover from the second cell to the third cell;
determining, by the one or more processors, a second network synchronization offset as a function of the third TA and the fourth TA; and
generating, by the one or more processors, a second record identifying a second geolocation of a fourth client device participating in a third communications session through the second cell or the third cell based on the second network synchronization offset.

10. The method of claim 1, wherein, a distance for the first cell and the second cell is based on a latitude and longitude of each cell.

11. A system for correcting a timing advance (TA) in a communication network, comprising:
one or more processors, coupled with memory, the one or more processors configured to:
monitor signal records of the communications network each including one or more protocol data units (PDUs) of a different communications session between client devices and computing devices over the communications network;
detect, based on the monitoring, a signal record for a communications session between a first client device and a computing device based on the signal record including a set of PDUs indicating a first communications session initiation through a first cell, a handover of the first communications session from the first cell to a second cell, and communications session end at the second cell;
identify a first TA for a first period of the first communications session through the first cell and a second TA for a second period of the first communications session end through the second cell after the handover from the first cell to the second cell;
determine a network synchronization offset as a function of the first TA and the second TA; and
generate a record identifying a geolocation of a second client device participating in a second communications session through the first cell or the second cell based on the network synchronization offset.

12. The system of claim 11, the one or more processors configured to:
adjust the first cell or the second cell according to the network synchronization offset.

13. The system of claim 12, the one or more processors configured to:
adjust the first cell or the second based on an environmental factor for the first cell or the second cell.

14. The system of claim 11, wherein, when determining the network synchronization offset, the one or more processors configured to:
modify, using a first function, the first TA to correspond to a first distance;
modify, using the first function, the second TA to correspond to a second distance; and
generate, using an aggregation function on the first distance and the second distance, a third distance.

15. The system of claim 14, the one or more processors configured to:
generate the network synchronization offset by executing a correction function on the third distance.

16. The system of claim 11, the one or more processors configured to:
determine an updated geo-location of the first client device by applying the network synchronization offset to correct an initial geo-location of the first client device to improve an accuracy of the updated geo-location without global positioning system (GPS) data.

17. The system of claim 11, wherein the first cell and the second cell are a base station (BS), wherein the BS is an eNodeB BS.

18. The system of claim 11, the one or more processors configured to:
determine the first TA as an average of TA1 values during the first period of the communications session; and
determine the second TA as an average of TA2 values during the second period of the communications session.

19. The system of claim 11, the one or more processors configured to:
detect, based on the monitoring, a second signal record for a communications session between a third client device and the computing device based on the second signal record including a set of PDUs indicating a second communications session initiation through the second cell, a handover of the second communications session from the second cell to a third cell, and communications session end at the third cell;
identify a third TA for a third period of the second communications session through the second cell and a fourth TA for a fourth period of the second communications session end through the third cell after the handover from the second cell to the third cell;
determine a second network synchronization offset as a function of the third TA and the fourth TA; and
generate a second record identifying a second geolocation of a fourth client device participating in a third communications session through the second cell or the third cell based on the second network synchronization offset.

20. The system of claim 11, wherein, a distance for the first cell and the second cell is based on a latitude and longitude of each cell.
